(19) United States
(12) Patent Application Publication
(10) Pub. No.: US 2018/0088202 A1
(43) Pub. Date: Mar. 29, 2018

(54) APPARATUS AND METHOD FOR RELOCATING AN ARTICULATING-ARM COORDINATE MEASURING MACHINE

(71) Applicant: FARO Technologies, Inc., Lake Mary, FL (US)

(72) Inventors: Simon Raab, Santa Barbara, CA (US); Charles Pfeffer, Avondale, PA (US)

(21) Appl. No.: 15/274,471

(22) Filed: Sep. 23, 2016

(51) Int. Cl. G01S 3/786; G01B 5/008; G01S 17/06

(52) U.S. Cl. CPC G01S 3/786; G01S 17/06; G01B 5/008

(57) ABSTRACT

A system and method for coordinate measurement is provided. The system includes a laser tracker and a moveable articulated-arm coordinate measuring machine (AACMM). The AACMM has an articulated arm with a probe end and an actuator. A retroreflector is coupled to the probe end. When the AACMM is in a first position, the system emits a laser beam and measures a position of the retroreflector while the AACMM also measures the position of retroreflector. When the AACMM is in a second position, and based on an activation of the at least one actuator by an operator, the system transmits a signal from the AACMM to the laser tracker and rotates the laser tracker towards the second position in response to the laser tracker receiving the signal. A means for transforming the first or second coordinate system to a common coordinate frame of reference is provided.

### BACKGROUND

The present invention relates generally to a system for determining the position of an articulated arm coordinate measuring machine (AACMM), and in particular to a system and method of tracking the position of a probe end of an AACMM using a laser tracker.

A number of different metrology devices may be used to measure coordinates of points on an object. One of these devices belongs to a class of instruments that measure the coordinates of a point by probing the point with an articulated mechanical structure. The probing may be performed with a mechanical probe tip or with a non-contact scanning device. The position of the probe tip is determined by the readings of angular encoders located at the mechanical joints that interconnect the articulating segments. This type of device, whether it uses a mechanical probe tip or a scanner, is referred to as an articulated-arm coordinate measuring machine (AACMM), such as that described in commonly owned U.S. Pat. No. 5,402,582.

Another of these devices utilizes optical means, such as a laser, to measure the distance to the object. This type of device may be referred to as a laser tracker. The laser tracker measures the coordinates of a point by sending a laser beam to a retroreflector target that is in contact with the point. The laser tracker determines the coordinates of the point by measuring the distance and the two angles to the retroreflector. The distance is measured with a distance-measuring device such as an absolute distance meter or an interferometer. The angles are measured with an angle-measuring device such as an angular encoder. A gimbaled beam-steering mechanism within the instrument directs the laser beam to the point of interest. An example of a laser tracking device includes U.S. Pat. No. 4,790,651.

The AACMM is capable of being arranged into a variety of orientations. Due of this, it is able to measure “hidden” points; that is, points that are hidden from the line-of-sight view of a measuring device such as a laser tracker. On the other hand, the laser tracker can measure over a much larger volume than the AACMM.

While existing metrology devices are suitable for their intended purpose the need for improvement remains, particularly in providing a way to locate the position of the AACMM when it is moved to different locations about an object being measured.

### SUMMARY

In accordance with an embodiment, a system for coordinate measurement is provided. The system includes a laser tracker and a moveable articulated-arm coordinate measuring machine (AACMM) that is movable from a first position to a second position, the AACMM having an articulated arm with a probe end opposite a base, the AACMM having at least one actuator. A retroreflector is coupled to the probe end. Wherein in a first instance, when the AACMM is in a first position, the system is operable to emit a first laser beam from the laser tracker and measure a position of the retroreflector relative to the laser tracker in a first coordinate system while the AACMM also measures the position of retroreflector relative to the AACMM in a second coordinate system. Wherein in a second instance, where the AACMM is in a second position, the system is operable based on an activation of the at least one actuator by an operator to transmit a signal from the AACMM to the laser tracker and rotating the laser tracker towards the second position in response to the laser tracker receiving the signal. A means for transforming the first coordinate system and/or the second coordinate system to a common coordinate frame of reference is provided in the first instance.

In accordance with embodiment, another system for coordinate measurement is provided. The system including a laser tracker having a first processor and a first non-transitory memory, the first non-transitory memory having first computer readable instructions. A moveable articulated-arm coordinate measuring machine (AACMM) is provided having an articulated arm with a probe end opposite a base, the AACMM having at least one actuator, the AACMM further having a second processor and a second non-transitory memory, the second non-transitory memory having second computer readable instructions. A retroreflector is coupled to the probe end. Wherein in a first instance, with the AACMM at a first position, the first processor is operable to execute the first computer readable instructions to emit a laser beam from the laser tracker and measuring a position of the retroreflector relative to the laser tracker in a first coordinate system and the second processor is operable to execute the second computer readable instructions to measure the position of retroreflector relative to the AACMM in a second coordinate system. Wherein in a second instance with the AACMM being located at a second position, the second processor is operable to execute the second computer readable instructions based on an activation of the at least one actuator by an operator to transmit a signal from the AACMM to the laser tracker and rotating the laser tracker towards the second position in response to the laser tracker receiving the signal. A means for transforming the first coordinate system or the second coordinate system to a common coordinate frame of reference is provided in the first instance.

In accordance with embodiment, a method for coordinate measurement is provided. The method includes placing a laser tracker at a first location. A moveable articulated-arm coordinate measuring machine (AACMM) is placed at a second location to which a retroreflector has been attached thereto. A laser beam is sent and reflected to the laser tracker to the retroreflector in order to measure a position of the retroreflector in a first coordinate system with the AACMM at the second location. The position of the retroreflector is measured with the AACMM while the retroreflector is located at the second position to measure the position of the retroreflector relative to the AACMM in a second coordinate system. The AACMM is moved to a third position. A first actuator is actuated when the AACMM is in the third position and transmitting a first signal to the laser tracker. The laser tracker is rotated in a first direction in response to the signal.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a laser tracker in accordance with an embodiment of the invention;

FIG. 2 is a perspective view of an articulated arm coordinate measurement machine (AACMM) in accordance with an embodiment of the invention;

FIG. 3 is a perspective view of an AACMM used in conjunction with a laser tracker;

FIG. 4 is an exploded, perspective view of a retroreflector clamp assembly;

FIG. 5 is a perspective view of the AACMM relocated to a second position through the use of the laser tracker;

FIG. 6 is a perspective view of a mounted sphere assembly;

FIG. 7 and FIG. 8 are perspective views of the retroreflector nest in contact with the mounted sphere; and

FIG. 9 and FIG. 10 are perspective view of an AACMM with reference made to the mathematical nomenclature.

The detailed description explains embodiments of the disclosure, together with advantages and features, by way of example with reference to the drawings.

### DETAILED DESCRIPTION OF EXEMPLARY EMBODIMENT

Embodiments of the present invention provide advantages in allowing a rapid determination of the position of an articulated-arm coordinate measurement machine (AACMM) with a laser tracker when the AACMM has been moved from a first position to a second position. Embodiments of the present invention provide advantages in allowing an operator to remotely steer the laser tracker to orient the laser track towards the AACMM in a new position. Embodiments of the present invention further provide advantages in allowing the operator to steer the laser tracker using control functions on the AACMM. In still further embodiments, the steering of the laser tracker may be performed using a mobile device, such as a cellular phone.

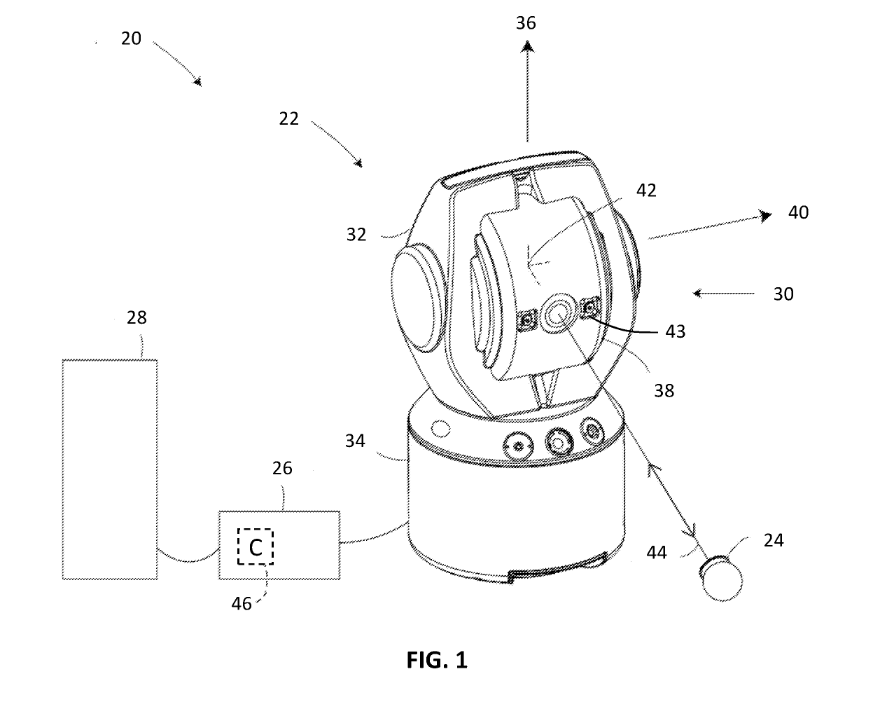

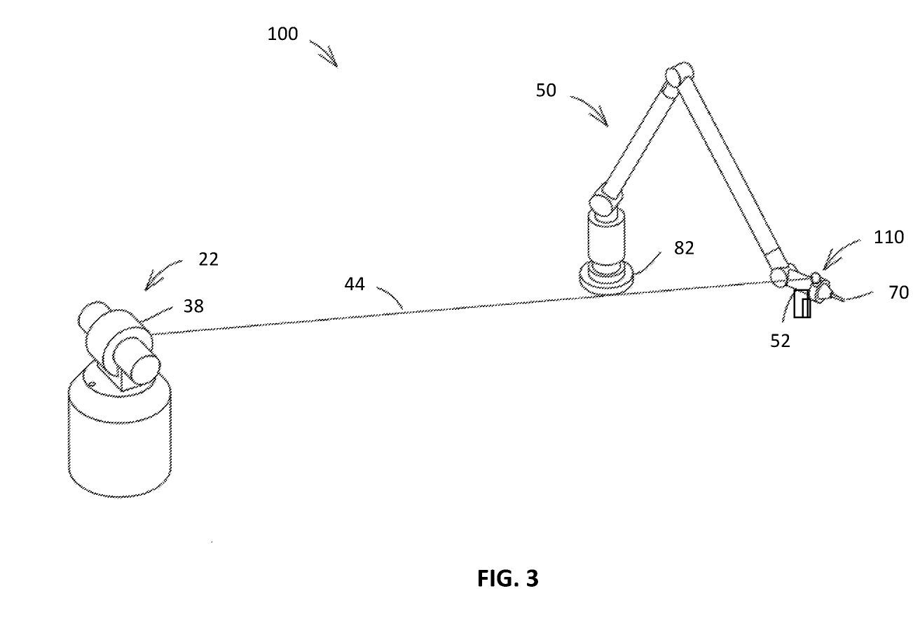

Referring now to FIG. 1, an exemplary laser tracker system 20 is shown that may be used in a large-scale coordinate probing system 100 (FIG. 3). The laser tracker system 20 may include a laser tracker 22, a retroreflector target 24, an optional auxiliary unit processor 26, and an optional auxiliary computer 28. An exemplary gimbaled beam-steering mechanism 30 of laser tracker 22 comprises a zenith carriage 32 mounted on an azimuth base 34 and rotated about an azimuth axis 36. A payload 38 is mounted on the zenith carriage 32 and rotated about a zenith axis 40. Zenith axis 40 and azimuth axis 36 intersect orthogonally, internally to tracker 22, at gimbal point 42, which is typically the origin for distance measurements. A laser beam 44 virtually passes through the gimbal point 42 and is pointed orthogonal to zenith axis 40. In other words, laser beam 44 lies in a plane approximately perpendicular to the zenith axis 40 and that passes through the azimuth axis 36. Outgoing laser beam 44 is pointed in the desired direction by rotation of payload 38 about zenith axis 40 and by rotation of zenith carriage 32 about azimuth axis 36. A zenith angular encoder, internal to the tracker, is attached to a zenith mechanical axis aligned to the zenith axis 40. An azimuth angular encoder, internal to the tracker, is attached to an azimuth mechanical axis aligned to the azimuth axis 36. The zenith and azimuth angular encoders measure the zenith and azimuth angles of rotation to relatively high accuracy. Outgoing laser beam 44 travels to the retroreflector target 24, which might be, for example, a spherically mounted retroreflector (SMR) as described above. By measuring the radial distance between gimbal point 42 and retroreflector 24, the rotation angle about the zenith axis 40, and the rotation angle about the azimuth axis 36, the position of retroreflector 24 is found within the spherical coordinate system of the tracker. As will be discussed in more detail herein, the retroreflector 24 may be coupled to a probe end of an AACMM to allow the laser tracker system 20 to determine the position of the AACMM and transform the coordinate data acquired by the AACMM into a common coordinate frame of reference.

In an embodiment, the optional unit processor 26, or auxiliary computer 28 may include communications circuit 46. As will be discussed in more detail herein, the communications circuit 46 may transmit and receive signals from other metrology devices. The communications circuit 46 may transmit over any suitable communications medium, such as a wired or wireless communications medium for example. In an embodiment, the signals may allow an external device, such as an AACMM for example, to control the movement of the payload 38 about the azimuth axis 36, the zenith axis 40 or a combination thereof.

Outgoing laser beam 44 may include one or more laser wavelengths. For the sake of clarity and simplicity, a steering mechanism of the sort shown in FIG. 1 is assumed in the following discussion. However, other types of steering mechanisms are possible. For example, it is possible to reflect a laser beam off a mirror rotated about the azimuth and zenith axes. Other types of steering mechanisms may use mirror galvometers that rotate to steer the direction of the laser beam 44. It should be appreciated that the techniques described herein are applicable, regardless of the type of steering mechanism.

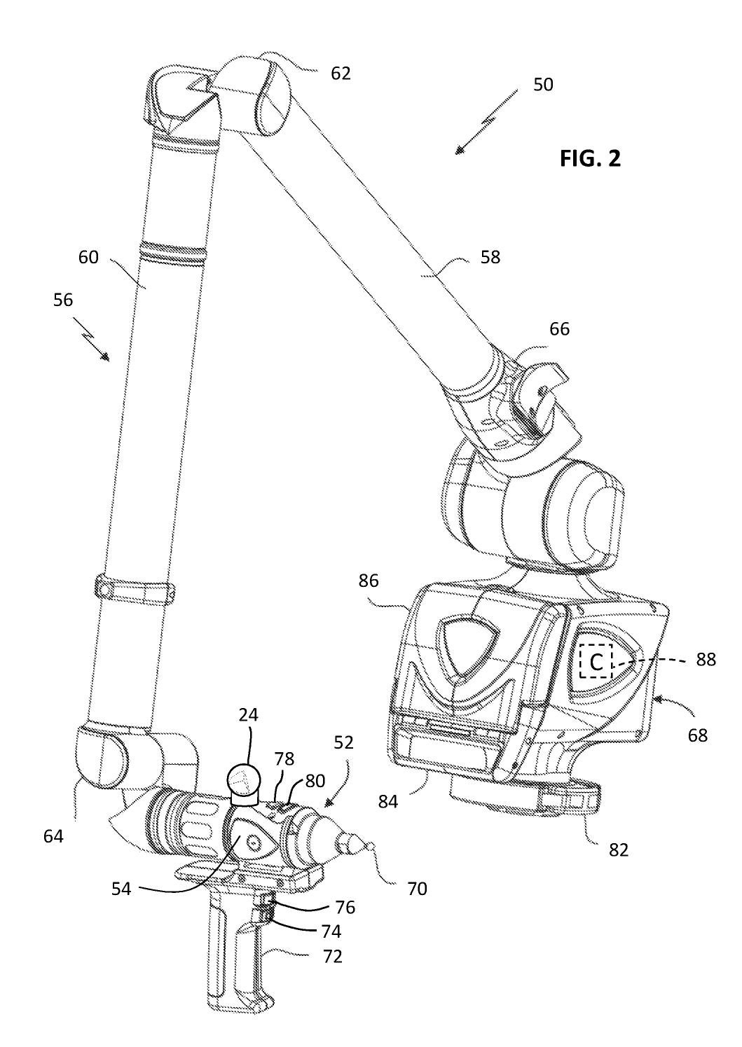

Referring now to FIG. 2, an exemplary AACMM 50 is shown that may be used in a large-scale coordinate probing system 100 (FIG. 3). The exemplary AACMM 50 may comprise a six or seven axis articulated measurement device having a probe end 52 that includes a measurement probe housing 54 coupled to an arm portion 56 of the AACMM 50 at one end. The arm portion 56 comprises a first arm segment 58 coupled to a second arm segment 60 by a first grouping of bearing assemblies 62 (e.g., two bearing cartridges). A second grouping of bearing assemblies 64 (e.g., two bearing cartridges) couples the second arm segment 60 to the measurement probe housing 54. A third grouping of bearing assemblies 66 (e.g., three bearing cartridges) couples the first arm segment 58 to a base 68 located at the other end of the arm portion 56 of the AACMM 50. Each grouping of bearing assemblies 62, 64, 66 provides for multiple axes of articulated movement. Also, the probe end 52 may include a measurement probe housing 54 that comprises the shaft of the seventh axis portion of the AACMM 50 (e.g., a cartridge containing an encoder system that determines movement of the measurement device, for example a probe 52, in the seventh axis of the AACMM 50). In this embodiment, the probe end 52 may rotate about an axis extending through the center of measurement probe housing 54. In use of the AACMM 50, the base 68 is removably affixed to a work surface.

Each bearing assembly within each bearing assembly 62, 64, 66 typically contains an encoder system (e.g., an optical angular encoder system). The encoder system (i.e., transducer) provides an indication of the position of the respective arm segments 58, 60 and corresponding bearing assemblies 62, 64, 66 that all together provide an indication of the position of a probe 70 with respect to the base 68 (and, thus, the position of the object being measured by the AACMM 50 in a certain frame of reference—for example a local or global frame of reference). The arm segments 58, 60 may be made from a suitably rigid material such as but not limited to a carbon composite material for example. A portable AACMM 50 with six or seven axes of articulated movement (i.e., degrees of freedom) provides advantages in allowing the operator to position the probe 70 in a desired location within a 360° area about the base 68 while providing an arm portion 56 that may be easily handled by the operator. However, it should be appreciated that the illustration of an arm portion 56 having two arm segments 58, 60 is for exemplary purposes, and the claimed invention should not be so limited. An AACMM 50 may have any number of arm segments coupled together by bearing assemblies (and, thus, more or less than six or seven axes of articulated movement or degrees of freedom).

The probe 70 is detachably mounted to the measurement probe housing 54, which is connected to bearing assembly 64. In an embodiment, a handle 72 may be removable with respect to the measurement probe housing 54 by way of, for example, a quick-connect interface.

In exemplary embodiments, the probe housing 54 houses a removable probe 70, which is a contacting measurement device and may have different tips 70 that physically contact the object to be measured, including, but not limited to: ball, touch-sensitive, curved and extension type probes. In other embodiments, the measurement is performed, for example, by a non-contacting device such as the LLP. In an embodiment, the handle 72 is replaced with the LLP using the quick-connect interface. Other types of measurement devices may replace the removable handle 72 to provide additional functionality. Examples of such measurement devices include, but are not limited to, one or more illumination lights, a temperature sensor, a thermal scanner, a bar code scanner, a projector, a paint sprayer, a camera, or the like, for example.

In an embodiment, the AACMM 50 includes the removable handle 72 that provides advantages in allowing accessories or functionality to be changed without removing the measurement probe housing 54 from the bearing assembly 64. The removable handle 72 may also include an electrical connector that allows electrical power and data to be exchanged with the handle 72 and the corresponding electronics located in the probe end 52. The electronics in the probe end 52 are coupled for communication to the electronic data processing system of the AACMM 50 by one or more busses (electrical or optical) that extend through the arm portion 56. In an embodiment, the handle may include actuators 74, 76 and the probe housing 54 may include actuators 78, 80. As will be discussed in more detail herein, in an embodiment, the actuators 74, 76, 78, 80 may be used by an operator to steer the laser beam 44 from laser tracker 22 towards the probe end 52.

In various embodiments, each grouping of bearing assemblies 62, 64, 66 allows the arm portion 56 of the AACMM 50 to move about multiple axes of rotation. As mentioned, each bearing assembly 62, 64, 66 includes corresponding encoder systems, such as optical angular encoders for example, that are each arranged coaxially with the corresponding axis of rotation of, e.g., the arm segments 106, 108. The optical encoder system detects rotational (swivel) or transverse (hinge) movement of, e.g., each one of the arm segments 58, 60 about the corresponding axis and transmits a signal to an electronic data processing system within the AACMM 50. Each individual raw encoder count is sent separately to the electronic data processing system as a signal where it is further processed into measurement data.

The base 68 may include an attachment device or mounting device 82. The mounting device 82 allows the AACMM 50 to be removably mounted to a desired location, such as an inspection table, a fixture, a tripod, a machining center, a wall or the floor, for example. In one embodiment, the base 68 includes a handle portion 84 that provides a convenient location for the operator to hold the base 68 as the AACMM 50 is being moved. In one embodiment, the base 68 further includes a movable cover portion 86 that folds down to reveal a user interface, such as a display screen.

In accordance with an embodiment, the base 68 of the portable AACMM 50 contains or houses an electronic circuit having an electronic data processing system that includes two primary components: a base processing system that processes the data from the various encoder systems within the AACMM 50 as well as data representing other arm parameters to support three-dimensional positional calculations; and a user interface processing system that includes an on-board operating system, a touch screen display, and resident application software that allows for relatively complete metrology functions to be implemented within the AACMM 50 without the need for connection to an external computer. In an embodiment, the base processing system may include a communications circuit 88. The communications circuit 88 being operable to transmit and receive signals to/from external devices, such as laser tracker 22 for example. In an embodiment, the communications circuit 88 is operable to receive signals from the actuators 74, 76, 78, 80 and transmit a signal to the laser tracker 22 in response. The communications circuit 88 may transmit over any suitable communications medium, such as a wired or wireless communications medium for example. It should be appreciated that in other embodiments, the AACMM 50 may be configured with the user interface processing system arranged remote or distant from the device, such as on a laptop, a remote computer or a portable/mobile computing device (e.g. a cellular phone or a tablet computer).

The electronic data processing system in the base 68 may communicate with the encoder systems, sensors, and other peripheral hardware located away from the base 68 (e.g. the actuators 74, 76, 78, 80, or a laser line probe that can be mounted in place of the removable handle 72 on the AACMM 50). The electronics that support these peripheral hardware devices or features may be located in each of the bearing assemblies 62, 64, 55 located within the portable AACMM 50.

In the exemplary embodiment, the retroreflector 24 is coupled to the probe end housing 54. As will be discussed in more detail below, the coupling of the retroreflector 24 to the housing 54 allows the laser tracker 22 to determine to the location of the probe end 52. In an embodiment, the retroreflector 24 is coupled in a predetermined relationship with the probe tip 70 or the base 68 to allow registration of the coordinate data acquired by the AACMM 50 to be transformed into a common frame of reference based at least in part on the coordinate data acquired by the laser tracker 22.

Referring now to FIG. 3, an exemplary embodiment is shown large-scale coordinate probing system 100. Probing system 100 comprises AACMM 50, retroreflector clamp assembly 110, and laser tracker 22. It should be appreciated that illustrated embodiment is for clarity purposes and the claimed invention should not be so limited. In other embodiments, other orientations, arrangements, set-ups, and variations may be used and are contemplated depending upon the specific application in the field for example.

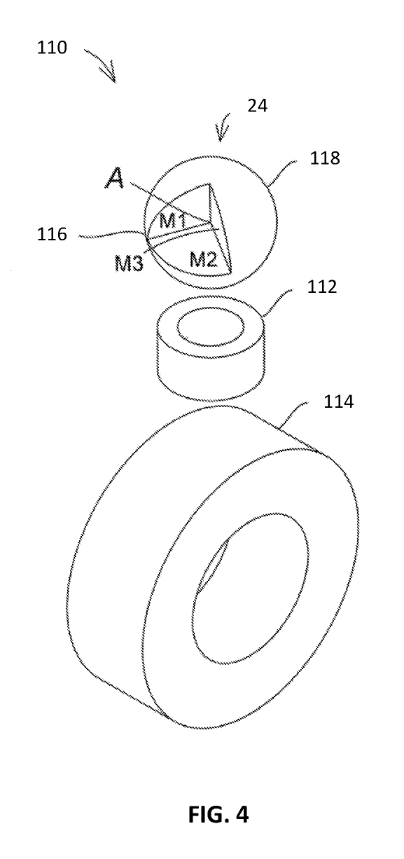

Referring now to FIG. 4, an exploded view is shown of a retroreflector clamp assembly 110, which comprises spherically mounted retroreflector (SMR) 24, kinematic nest 112, and clamp 114. SMR 24 comprises cube-corner retroreflector 116 embedded within partial sphere 118. Cube-corner retroreflector 116 comprises three flat mirror segments (M1, M2, M3) which are joined together in such a way that each glass segment makes a ninety degree angle with respect to the other two glass segments. The point of common intersection of the three glass segments is called the apex “A” of SMR 24. The apex “A” is located at the spherical center of partial sphere 118.

Kinematic nest 112 attaches to the top of clamp 114. In an embodiment, the clamp 114 coupled to the probe end 52 of AACMM 50. Thus, the clamp 114 allows the retroreflector clamp assembly 110 to be placed onto AACMMS 0.

Kinematic nest 112 has three point-like contacts (not shown) onto which the spherical surface of SMR 24 rests. These point-like contacts ensure that the center of SMR 24 remains at the same point in space as SMR 24 is rotated. Kinematic nest 112 may contain a magnet in its base to that maintains SMR 310 in constant contact with the three point-like contacts.

As shown in FIG. 3, Laser tracker 22 emits laser beam 44 to SMR 24. Cube-corner retroreflector 116 reflects the light from the laser tracker back to the laser tracker 22 along the same line 44 as the outgoing laser beam. The laser tracker 22 monitors the position of the returning laser beam and adjusts the position of the payload 38 to keep the laser beam centered on SMR 24, even as the SMR 24 is moved from point to point. In this example, the operator moves the end of AACMM 50 to three distinct positions, but may also move the AACMM 50 to twelve or more positions or possibly one position only. At each position, measurements of the SMR 24 retroreflector coordinates are made by both AACMM 50 and laser tracker 22. AACMM 50 does this by using its angular encoders which typically are located in the bearing assemblies 62, 64, 66 of AACMM 50. Laser tracker 22 does this by using its distance meter and angular encoders (not shown). It should be appreciated that other types of encoders and distance meters may also be used.

By comparing this data collected by AACMM 50 and laser tracker 22, a transformation matrix is determined for converting from the coordinate system of AACMM 50 to the coordinate system of laser tracker 22 or vice versa. Alternatively, both sets of data can be converted into some other preferred coordinate system xyz.

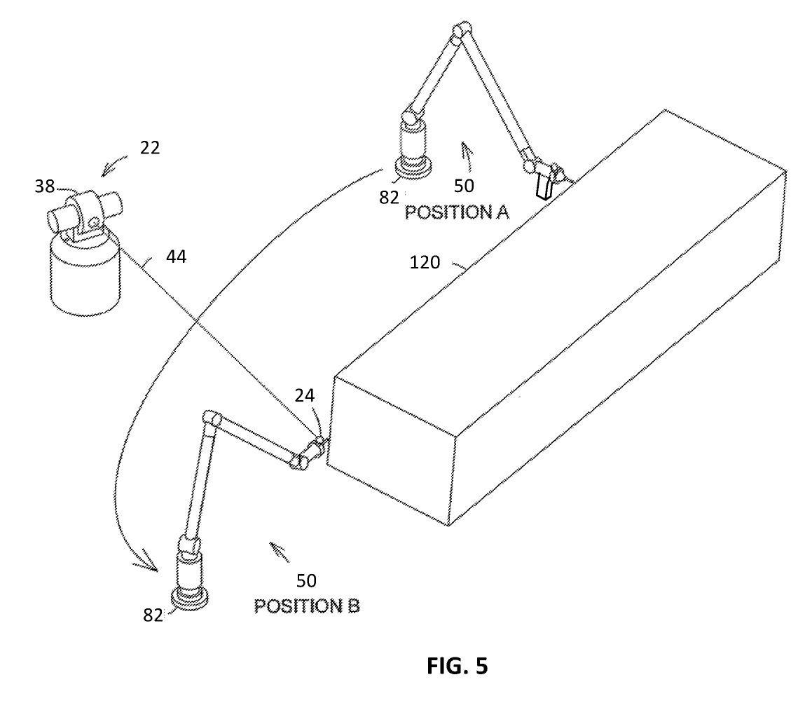

When measuring a large object with AACMM 50, it is often necessary to move AACMM 50 to a different position in order to measure other portions of the large object that are not reachable or accessible to measurement from the first position. This action of moving AACMM 50 to a different position is referred to as “relocation.” The above procedure of simultaneously measuring the position of SMR 24 with AACMM 50 and laser tracker 22 is performed whenever AACMM 50 is relocated (see FIG. 5 where AACMM 50 is moved from position A to position B for example). This permits the data collected from the several locations of AACMM 50 to be registered together in the same common coordinate system in the same frame of reference. With the method described above, AACMM 50 can be quickly and accurately relocated to any position within the measurement volume of laser tracker 22.

This provides advantages over prior art solutions where such an relatively easy relocation process is not possible because several nests (for example four nests) were usually placed on a floor as a frame of reference for an AACMM. Thus, the nests had to also be relocated when an AACMM was relocated and all points of reference had to be relatively recalibrated for example.

An example of AACMM 50 moved from a first position (POSITION A) to a second position (POSITION B) to measure a large object 120 is shown in FIG. 5. In this figure, the laser tracker 22 provides fast and accurate relocation of the AACMM 50.

The following techniques may also be implemented to improve the accuracy of relocating an AACMM: (1) measure many points (for example, more than three) with the AACMM and laser tracker; (2) measure points separated as much as possible in three-dimensional space (that is, near the outer edges of the articulated-arm measurement envelope); and (3) measure points covering all three dimensions (that is, avoid collecting points that lie entirely on or near a plane).

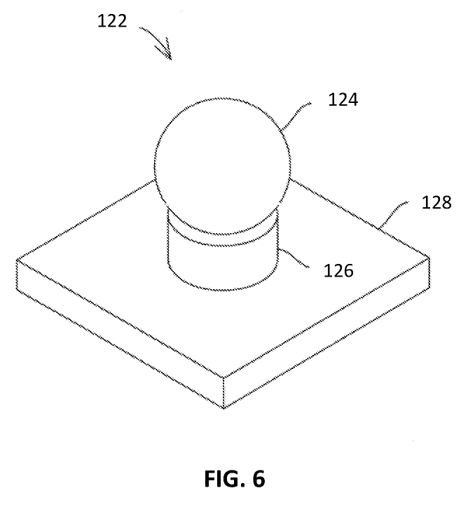

When retroreflector clamp assembly 110 is first attached to AACMM 50, the coordinates of SMR 24 are found in relation to the frame of reference of probe end 52. In one embodiment, a compensation procedure is performed using mounted sphere 122 shown in FIG. 6. This may also be termed an “initial compensation” procedure, because is it may only be performed when the retroreflector clamp assembly 110 is first attached to AACMM 50.

Mounted sphere 122 comprises metal sphere 124, magnetic nest 126, and base 128. Metal sphere 124 may have the same diameter as SMR 24, for example. Magnetic nest 126 has three point-like contacts (not shown) onto which the metal sphere 124 rests. A magnet (not shown) holds metal sphere 124 securely against the three point-like contacts. Magnetic nest 126 is attached to base 128, which in turn is attached to the floor on another stable surface.

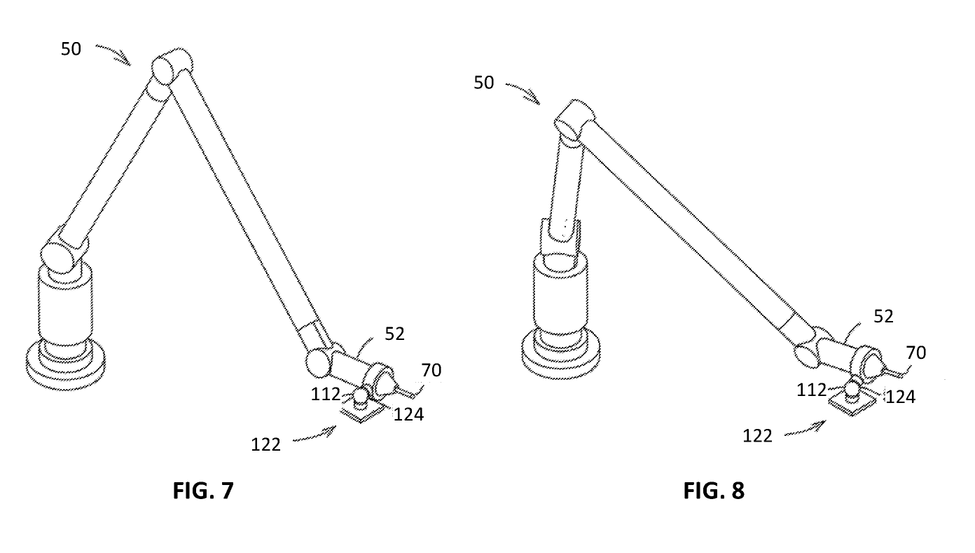

In an embodiment, at the start of the compensation procedure to find the SMR position, SMR 24 is removed from kinematic nest 112. Kinematic nest 112 is brought in contact with metal sphere 124, which is sitting on magnetic nest 126. This is shown in FIG. 7. Subsequently, the links or sections of AACMM 50 are moved into a different position, as shown in FIG. 8. The exact position of kinematic nest 112 is not important. By repositioning the links at least one more time, the angles on the angular encoders of AACMM 50 can be used to determine the position of the center of SMR 24. In an embodiment, the reposition of the links may be performed a plurality of times.

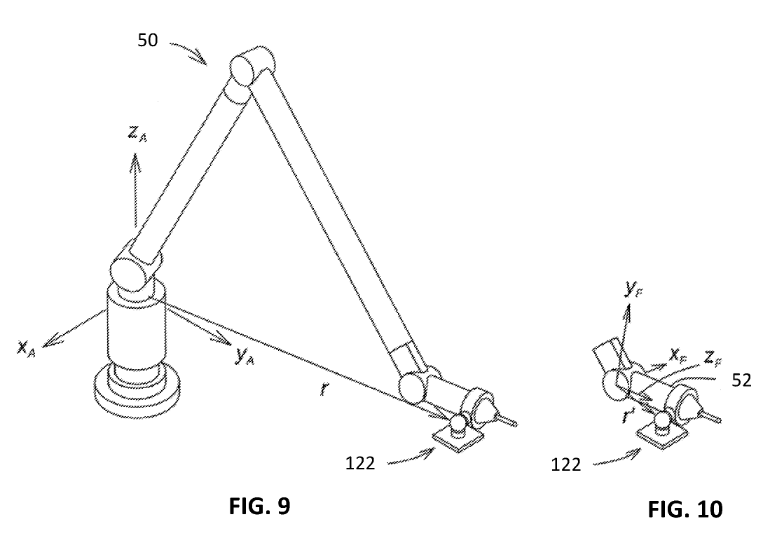

The mathematics for determining coordinates using articulated links such as are found on robots or AACMM's are well known. For example, the relevant equations are described in chapters 3 and 4 of Robot Modeling and Kinematics by Rachid Manseur. With these equations, one can relate the position F′ of the center of metal sphere 124 within the frame of reference of probe end 52 to the position r of the center of metal sphere 124 within the fixed frame of reference of base 68 of AACMM 50. Possible vectors r̅′ and r̅ for a particular AACMM are shown in FIG. 9 and FIG. 10. To clarify the meaning of these vectors, local coordinate systems (x_{A}, y_{A}, z_{A}) and (x_{F}, y_{F}, z_{F}) for AACMM 50 and probe end 52, respectively, are shown in FIG. 9 and FIG. 10. In the case of the compensation procedure to find the coordinates of the SMR as described above, the constraint of metal sphere 124 causes vectors r̅′ and r̅ to remain constant even as the links of AACMM 50 are moved about. The equation that relates the two vectors is:

r̅=T(θ̅ᵢ)·r̅′. (1)

In this equation, T(θ̅₁) is a 4×4 transformation matrix that depends on the so-called Denavit-Hartenberg (DH) parameters for each link, as explained in the book by Manseur cited above. For each link, only one of DH parameters, the link angle 9, varies during the compensation procedure. The other DH parameters are characteristic of a particular AACMM and will already have been determined by a factory compensation procedure carried out at the time the AACMM is manufactured. The fixed parameters are determined by a separate factory compensation procedure. The vector notation θ̅ᵢ indicates that T is a function of the angular encoder readings for all of the joints in the Arm, and i indicates the i^{th} measurement, where each measurement corresponds to a different position of AACMM, two example positions of which are shown in FIG. 7 and FIG. 8. If AACMM 50 is moved to a large number of different positions, there will not be a unique solution to Equation (1). Instead, the best estimate of the vectors r̅′ and r̅ is made by minimizing the total residual error. For the measurement, the residual error is defined as:

resᵢ=|T(θ̅ᵢ)·r̅′−r̅|. (2)

To minimize the total residual error, r̅′ and r̅ are selected to minimize the sum of the square of the resᵢ values. In this case, r̅′ and r̅ are each represented by three coordinate values (for example, x, y, and z), so that there are six parameter values that need to be found. The procedure for selecting parameters to minimize a sum of squared values is well known in the art and is readily carried out using widely available software. This procedure will therefore not be discussed further.

As mentioned previously, AACMM 50 is conveniently relocated by simultaneously measuring by position of SMR 24 with AACMM 50 and laser tracker 22 with SMR 24 moved to several different positions. The measurements collected by AACMM 50 are related to the measurements of laser tracker 22 through the equation:

s̅=M(rx,ry,rz,tx,ty,tz)·s̅′. (3)

In this equation, s̅ and s̅′ are the coordinates of the SMR 24 in the frame of reference of laser tracker 22 and the frame of reference of AACMM 50, respectively. The quantities rx, ry, rz are the Euler angles representing rotations about the X, Y and Z axes respectively, and tx, ty, tz are the displacements in X, Y and Z respectively. The matrix M(rx, ry, rz, tx, ty, tz) transforms the coordinates of SMR 24, as measured by the relocated AACMM 50, into the frame of reference of laser tracker 22 which in this example is the common coordinate frame of reference. However, it possible to use, or assign, any suitable frame of reference to be the common coordinate frame of reference. This matrix M(rx, ry, rz, tx, ty, tz) is the entity determined by the relocation procedure, and it the matrix may be computed in any suitable means such as in a processor or in software (not shown) for example. Once it is known, it can equally be applied to a measurement of a probe tip 70 attached to the probe end 52. The probe-tip 70 coordinate, as measured by AACMM 50, is transformed by matrix M(rx,ry,rz,tx,ty,tz) to give the coordinates of the probe tip 70 in the frame of reference of laser tracker 22.

To find M(rx, ry, rz, tx, ty, tz), the residual error for the i^{th} measurement is defined as

resᵢ=|M(rx,ry,rz,tx,ty,tz)·s̅′−s̅|. (4)

A standard least-squares fit calculation is performed to find the values of the 6 fit parameters rx,ry,rz,yx,ty,tz that minimize the sum of the squares of the residual errors.

It should be appreciated that when the AACMM 50 is moved from Position A to Position B, the laser tracker 22 may have to reorient the payload 38 in order to reacquire or “find” the retroreflector 24. In one embodiment, the laser tracker 22 may have a predetermined search pattern that is activated when the retroreflector 24 is moved and the optical connection between the laser tracker 22 and the retroreflector 24 is interrupted.

In an embodiment, the laser tracker 22 may include at least one camera and a modulated light source, such as light source 43 (FIG. 1) for example. A camera axis may be coaxial with the measurement beam or offset from the measurement beam by a fixed distance or angle. A location camera may be used to provide a wide field of view to locate the retroreflector 24 using image analysis. The modulated light source being placed near the location camera optical axis may illuminate the retroreflector 24, thereby making it easier to identify. In this case, the retroreflector 24 flashes in phase with the illumination, whereas background objects do not. Once the position of the retroreflector 24 is determined, the laser tracker 22 rotates the payload 38 about the zenith axis 40 and azimuth axis 36 to direct the laser beam 44 onto the retroreflector 24. The use of the location camera allows the orienting of the laser tracker 22 sufficiently close to the direction of the retroreflector 24 to allow the internal positioning mechanism (e.g. a position sensor) to allow the laser tracker 22 to lock onto the retroreflector 24.

It should be appreciated that in some embodiments, it may be difficult for the laser tracker 22 to find the retroreflector 24. For example, in one embodiment the movement of the AACMM 50 may be beyond the field of view of the location camera. In another embodiment, multiple retroreflectors may be either viewable to a location camera. As such, it may be difficult for the laser tracker 22 to reacquire the retroreflector 24 and not inadvertently lock onto a different retroreflective device. It should be appreciated that when the object 120 is large, it may be time consuming or inconvenient for the operator to move from the location of the AACMM 50 to the laser tracker 22 and manually reposition the payload 38 to be oriented in the right direction.

In an embodiment, the AACMM 50 and the laser tracker 22 are operably coupled to communicate, such as via communications circuits 46, 88 for example. In an embodiment the communications circuits 46, 88 allow for bidirectional communication between the laser tracker 22 and the AACMM 50. In another embodiment, the communication circuits 46, 88 provide for unidirectional communication from the AACMM 50 to the laser tracker 22.

In an embodiment, the AACMM 50 is operable to transmit a signal in response to an input from the operator, such as by activating one of the actuators 74, 76, 78, 80. The signal is received by the laser tracker 22, which rotates the payload 38 about the zenith axis 40 or the azimuth axis 36 in response. In an embodiment, a first actuator (e.g. actuator 74) rotates the laser tracker 22 in a first direction and a second actuator (e.g. actuator 76) rotates the laser tracker in a second direction. In an embodiment, the first direction and second direction are in opposite directions. In another embodiment, the first direction is about the azimuth axis 36 and the second direction is about the zenith axis 40. Thus the operator may control the orientation of the payload 38 and direct the laser beam 44 towards Position B. In an embodiment, the operator controls of the rotation about the zenith axis 40 using actuators 74, 76 and about the azimuth axis using actuators 78, 80. It should be appreciated that each actuator in each actuator pair rotates the payload 38 in a different direction.

In one embodiment, as the payload 38 is rotated about the azimuth axis 36, the payload 38 is oriented so that the laser beam 44 extends horizontally (e.g. parallel with the floor or work surface). In other words, the angle of the payload about the zenith axis 40 is at 0 degrees.

When the laser tracker 22 has been rotated such that the laser beam 44 is close to the retroreflector 24, the operator may initiate a lock-on procedure wherein the laser tracker 22 searches for and centers the laser beam 44 on the retroreflector 24. The searching process by the laser tracker 22 may be by any suitable method as is known in the art. In one embodiment, the laser tracker 22 includes a light 43 that flashes. The light reflected by the retroreflector 24 is acquired by a camera, which allows the laser tracker 22 to identify the position of the retroreflector 24. In another embodiment, a position sensor such as that described in commonly owned U.S. Pat. No. 8,537,376, the contents of which are incorporated by reference herein. The position sensor receives light from a beam splitter (e.g. a dichroic mirror) and compares the position of a returning light beam to an ideal retrace position. The control system of the laser tracker 22 then rotates the payload 38 to position the returning light at or close to the ideal retrace position.

In an embodiment, the laser tracker 22 may be put into lock-on mode by using a combination of actuator activations (e.g. depress two actuators simultaneously) where the laser tracker 22 searches for the retroreflector 24. In still another embodiment, the actuators may be on a user interface of an attached computing device, such as auxiliary unit processor 26 or auxiliary computer 28 for example. In still another embodiment, the computing device may be a mobile computing device (e.g. a cellular phone, a tablet or a laptop computer) that is wirelessly connected to the AACMM 50 and the laser tracker 22. The computing device may have one or more user interface elements (e.g. buttons or arrow keys) that cause one or more signals to be transmitted to the laser tracker 22 for rotating the payload 38.

In one embodiment, once the laser tracker 22 is locked-on to the retroreflector 24, the operator may proceed with making measurements on the object 120 in Position B. As the AACMM 50 acquires measurements, the laser tracker 22 measures the position of the retroreflector 24 relative to the laser tracker frame of reference and the AACMM 50 measures the position of the retroreflector 24 in the AACMM frame of reference. The coordinates of the points measured by the AACMM 50 may then be transformed into the frame of reference of the laser tracker 22 for example. This transformation may be performed as the measurements are made or later during post processing.

It should be appreciated that while embodiments herein refer to the AACMM as being moved between two locations/positions, this is for exemplary purposes and the claimed invention should not be so limited. In other embodiments, the AACMM 50 may be moved between a plurality of positions. At each new position, the actuators may be used to guide the rotation of the laser tracker 22 to an orientation that directs the laser beam 44 towards the retroreflector in the new position.

It will be apparent to those skilled in the art that, while an exemplary embodiment has been shown and described, various modifications and variations can be made to the apparatus and method of relocating an AACMM by measuring a retroreflector mounted on the AACMM with a laser tracker disclosed herein without departing from the spirit or scope of the invention. Accordingly, it is to be understood that the various embodiment has been described by way of illustration and not limitation.

1. A system for coordinate measurement comprising:
a laser tracker;
a moveable articulated-arm coordinate measuring machine (AACMM) that is movable from a first position to a second position, the AACMM having an articulated arm with a probe end opposite a base, the AACMM having at least one actuator;
the probe end comprising a probe housing operably coupled to the base via at least one bearing assembly;
a handle removably disposed with respect to the probe housing;
a retroreflector coupled to the probe housing;
wherein in a first instance, where the AACMM is in a first position, the system is operable to emit a first laser beam from the laser tracker and measure a position of the retroreflector relative to the laser tracker in a first coordinate system while the AACMM also measures the position of retroreflector relative to the AACMM in a second coordinate system; and
wherein in a second instance, where the AACMM is in a second position, the system is operable based on an activation of the at least one actuator by an operator to transmit a signal from the AACMM to the laser tracker and rotating the laser tracker towards the second position in response to the laser tracker receiving the signal;
a means for transforming the first coordinate system or the second coordinate system to a common coordinate frame of reference is provided in the first instance; and
the handle being configured to be removed and replaced with: one or more illumination lights; a temperature sensor; a thermal scanner; a bar code scanner; a projector; a paint sprayer; or, a camera.

2. The system of claim 1, wherein:
the at least one actuator includes a first actuator and a second actuator;
the AACMM is responsive to transmitting a first signal to the laser tracker in response to the activation of the first actuator and a second signal to the laser tracker in response to activation of the second actuator; and
the laser tracker rotates about an axis in a first direction in response to receiving the first signal and in a second direction in response to the second signal, the first direction being opposite the second direction.

3. The system of claim 2, wherein the axis is the azimuth axis.

4. The system of claim 2, wherein the axis is the zenith axis.

5. The system of claim 2, wherein the AACMM is responsive to transmit a third signal to the laser tracker, the laser tracker having a means for automatically searching for the retroreflector in response to receiving the third signal.

6. The system of claim 2, wherein in the second instance, the laser tracker is responsive to emitting a second laser beam from the laser tracker in order to measure a second position of the retroreflector relative to the laser tracker in a first coordinate system while the AACMM also measures the second position of retroreflector relative to the AACMM in a second coordinate system.

7. The system of claim 6, further comprising a means for transforming the first coordinate system and/or the second coordinate system to a common coordinate frame of reference in the second instance.

8. A system for coordinate measurement comprising:
a laser tracker having a first processor and a first non-transitory memory, the first non-transitory memory having first computer readable instructions;
a moveable articulated-arm coordinate measuring machine (AACMM) having an articulated arm with a probe end opposite a base, the probe end comprising a probe housing operably coupled to the base via at least one bearing assembly, a handle removably disposed with respect to the probe housing, the AACMM having at least one actuator, the AACMM further having a second processor and a second non-transitory memory, the second non-transitory memory having second computer readable instructions;
a retroreflector coupled to the probe housing;
wherein in a first instance with the AACMM at a first position, the first processor is operable to execute the first computer readable instructions to emit a laser beam from the laser tracker and measuring a position of the retroreflector relative to the laser tracker in a first coordinate system and the second processor is operable to execute the second computer readable instructions to measure the position of retroreflector relative to the AACMM in a second coordinate system; and
wherein in a second instance with the AACMM being located at a second position, the second processor is operable to execute the second computer readable instructions based on an activation of the at least one actuator by an operator to transmit a signal from the AACMM to the laser tracker and rotating the laser tracker towards the second position in response to the laser tracker receiving the signal;
a means for transforming the first coordinate system and/or the second coordinate system to a common coordinate frame of reference in the first instance; and
the handle being configured to be removed and replaced with: one or more illumination lights; a temperature sensor; a thermal scanner; a bar code scanner; a projector; a paint sprayer; or, a camera.

9. The system of claim 8, wherein:
the at least one actuator includes a first actuator and a second actuator;
the second processor is responsive to transmitting a first signal to the laser tracker in response to the activation of the first actuator and a second signal to the laser tracker in response to activation of the second actuator; and
the first processor rotates the laser tracker about an axis in a first direction in response to receiving the first signal and in a second direction in response to the second signal, the first direction being opposite the second direction.

10. The system of claim 9, wherein the axis is the azimuth axis.

11. The system of claim 9, wherein the axis is the zenith axis.

12. The system of claim 9, wherein the AACMM is responsive to transmit a third signal to the laser tracker, the laser tracker having a means for automatically searching for the retroreflector in response to receiving the third signal.

13. The system of claim 9, wherein in the second instance, the laser tracker is responsive to emitting a second laser beam from the laser tracker in order to measure a second position of the retroreflector relative to the laser tracker in a first coordinate system while the AACMM also measures the second position of retroreflector relative to the AACMM in a second coordinate system.

14. The system of claim 13, further comprising a means for transforming the first coordinate system and/or the second coordinate system to a common coordinate frame of reference in the second instance.

15. A method for coordinate measurement comprising:
providing a laser tracker and a moveable articulated-arm coordinate measuring machine (AACMM), the AACMM having an articulated arm with a probe end opposite a base, the probe end comprising a probe housing operably coupled to the base via at least one bearing assembly, a retroreflector coupled to the probe housing, the AACMM having at least one actuator and a handle removably disposed with respect to the probe housing, the handle being configured to be removed and replaced with: one or more illumination lights; a temperature sensor; a thermal scanner; a bar code scanner; a projector; a paint sprayer; or, a camera;
placing the laser tracker at a first location;
placing at a second location the AACMM;
sending and reflecting a laser beam from the laser tracker to the retroreflector in order to measure a position of the retroreflector in a first coordinate system with the AACMM at the second location;
measuring the position of the retroreflector with the AACMM while the retroreflector is located at the second position to measure the position of the retroreflector relative to the AACMM in a second coordinate system;
moving the AACMM to a third position;
actuating a first actuator when the AACMM is in the third position and transmitting a first signal to the laser tracker; and
rotating the laser tracker in a first direction in response to the signal.

16. The method of claim 15, further comprising transforming the measurements of the position of the retroreflector taken in first coordinate system and/or the second coordinate system to a common coordinate frame of reference.

17. The method of claim 15, further comprising actuating a second actuator when the AACMM is in the third position and transmitting a second signal to the laser tracker.

18. The method of claim 17, further comprising rotating the laser tracker in a second direction in response to the second signal.

19. The method of claim 18 wherein the first direction is opposite the second direction.

20. The method of claim 18, wherein the rotation in the first direction is about the azimuth axis and the rotation in the second direction is about the zenith axis.

21. The system of claim 1, wherein the rotating the laser tracker towards the second position in response to the laser tracker receiving the signal comprises, rotating the laser tracker towards the: one or more illumination lights; a temperature sensor; a thermal scanner; a bar code scanner; a projector; a paint sprayer; or, a camera.
